(19) United States
(12) Patent Application Publication
(10) Pub. No.: US 2021/0253800 A1
(43) Pub. Date: Aug. 19, 2021

(54) SILICONE MODIFICATION BY SURFACE HYDROSILYLATION

(71) Applicant: Virginia Commonwealth University, Richmond, VA (US)

(72) Inventors: Kenneth J. Wynne, Midlothian, VA (US); Ashraf KAYESH, Richmond, VA (US)

(73) Assignee: Virginia Commonwealth University, Richmond, VA (US)

(21) Appl. No.: 17/284,595

(22) PCT Filed: Oct. 11, 2019
(86) PCT No.: PCT/IB2019/058714

§ 371 Date: Apr. 12, 2021

Related U.S. Application Data
(60) Provisional application No. 62/744,270, filed on Oct. 11, 2018.

(51) Int. Cl. C08G 77/388; C08G 77/20; C08G 77/12; C09D 183/08

(52) U.S. Cl. CPC C08G 77/388; C09D 183/08; C08G 77/12; C08G 77/20

(57) ABSTRACT

A surface-modified poly(dimethylsiloxane) is provided, comprising a Pt-cured poly(dimethylsiloxane) elastomer, having a surface; and a plurality of —CH₂—CH₂—R groups covalently bound to the surface; wherein R is a substituted or unsubstituted, branched or unbranched alkyl, aryl, aralkyl, alkylsilyl, silyl, alkyl ether, alkyl amine, quaternary alkyl amine, or alkylcarbonyloxy group. Methods of making and using the surface-modified poly(dimethylsiloxane) are also provided.

### RELATED APPLICATIONS

This application claims the benefit of U.S. Application No. 62/744,270, filed Oct. 11, 2018, the entire contents of which are hereby incorporated by reference.

### GOVERNMENT SUPPORT

This invention was made with government support under Grant Number DMR1608022 awarded by the National Science Foundation (NSF). The government has certain rights in the invention.

### FIELD OF THE INVENTION

The invention provides methods for modifying the surface of Pt-cured poly(dimethylsiloxane), surface-modified poly(dimethylsiloxane) obtained thereby, and articles and uses incorporating the surface-modified poly(dimethylsiloxane).

### BACKGROUND

Poly(dimethylsiloxane) (PDMS) elastomeric materials or “silicones” are specialty polymers that have desirable properties for a broad range of applications that require thermal and chemical stability under harsh conditions. Applications for PDMS elastomers include microfluidics, flexible electronics and biomedical materials. Ease of processing into complex shapes, stability to sterilization, optical transparency and oxygen permeability are among characteristics that favor biomedical applications.

Surface and bulk properties of PDMS are attributed to the highly flexible —(CH₃)₂SiO)ₙ-“Dₙ” main chain with a T_{g} of −120° C. Although Si—O bonds are polar, methyl groups on silicon shield polarity so that the surface free energy of PDMS elastomers is low (23 dyn cm⁻¹). The well-known water resistance of PDMS elastomers is usually a benefit for coatings but hydrophobicity can compromise usefulness in some applications because bacteria, platelets, proteins and other biomolecules tend to adhere to the surface.

Plasma treatment is conventionally used to generate hydrophilic PDMS surfaces. A 30 s plasma exposure was found best for Sylgard 184 and a model silicone coating for obtaining increased the time for “hydrophobic recovery”, which is a return to hydrophobicity after a few hours. A related high energy ultraviolet/ozone treatment is a rapid, high energy approach to hydrophilization.

A combination of plasma, reaction with an atom transfer radical polymerization (ATRP) initiator and surface grafting of polyacrylamide gave a hydrophilic modification of Sylgard 184 (θ_{A}, 70°, θ_{R}, 0°) that resisted protein adsorption and did not show reversion to hydrophobicity. A variety of substrates including Sylgard 184 can be modified with an aqueous solution of polydopamine, which provides a hydrophilic nano-coating (water contact angle ˜50°). A hydrophilic PDMS surface with low levels of protein adsorption may be obtained by chemical processes such as networks prepared by click reactions between azidoalkylsiloxanes and alkynyl-modified siloxanes and/or PEGs.

Instead of high energy or lengthy chemical processes, a facile chemical approach for Pt-cured silicones has now been found and is described herein. It has now been found that surface chemical and physical characteristics are changed via the reaction of 1-alkenes with excess Si—H from the resident MD^{H}DM crosslinker. The inventors have found that simply by immersing freshly Pt-cured PDMS coatings in alkenes at ambient temperature results in covalent binding of the alkene to the PDMS surface by hydrosilylation. The reaction with vinyl 1-alkenes (CH₂═CH—R) is rapid, appearing to be near completion in a few of minutes. Results from ATR-IR spectroscopy, dynamic water contact angles, advancing/receding water contact angles, sliding water drop experiments and X-ray photoelectron spectroscopy confirm the functionalization of PDMS surface by 1-alkenes.

### BRIEF DESCRIPTION OF THE DRAWINGS

FIG. 1 presents some exemplary embodiments of 1-alkenes for surface modification.

FIG. 2 shows graphically one embodiment of a flow diagram for preparing Pt-cured silicone coatings followed by a post-cure treatment with 1-alkene.

FIG. 3 presents ATR-IR spectroscopic data for Sylgard (S-PDMS(5:1-40)) and laboratory prepared coatings (Pt-PDMS(5:1-40)) treated with 12-bromo-1-dodecene as a function of time.

FIG. 4 presents XPS spectra in the binding energy region for bromine (68 eV). A. Spectra for Pt-PDMS-12-Br, Pt-PDMS-8-Br and Pt-PDMS(5:1-40). B, Spectra for S-PDMS-12-Br, S-PDMS-8-Br and S-PDMS(5:1-40). Take-off angle 70°.

FIG. 6 presents contact angle and ATR-IR spectra for several embodiments. 6A presents contact angles (degrees) for (a) Pt-PDMS(5:1-40) (b) after a 3-min immersion in 1-dodecene and (c) after a second immersion; 6B shows corresponding Si—H ATR-IR spectra.

FIG. 7 presents onset of drop-sliding for A as prepared S-PDMS(5:1-40) and Pt-PDMS (5:1-40) and B after a 2 min dip in 1-dodecene. After treatment, the sliding angle decreases by over 30 degrees.

FIG. 8 presents contact angles for Pt-PDMS(5:1-40); A1, as prepared; A2 after treatment with 8 (FIG. 1) for 10 min/dilute HCl dip; B, ATR-IR for as prepared PDMS(5:1-40); B-a, as prepared; B-b after treatment with 8; B-c, after the HCl wash.

FIG. 9 shows data for protein adsorbed by the different embodiments of PDMS coatings. Dodecene treated coatings (rightmost grey bars, exemplary) were found to adsorb much higher amount of protein than the control (leftmost blue bars, comparative) and the dodecane (center orange bars, comparative) treated ones, for S-PDMS as well as Pt-PDMS.

### BRIEF DESCRIPTION OF THE SEVERAL EMBODIMENTS

Surface chemical and physical characteristics of silicone polymers are changed via the reaction of 1-alkenes with excess Si—H from the resident crosslinker. The inventors have found that simply by immersing freshly Pt-cured PDMS surface in alkenes at ambient temperature results in covalent binding of the alkene to the PDMS surface by hydrosilylation. The reaction with vinyl 1-alkenes (CH₂═CH—R) is rapid, appearing to be near completion in a few of minutes. Results from ATR-IR spectroscopy, dynamic water contact angles, advancing/receding water contact angles, sliding water drop experiments and X-ray photoelectron spectroscopy confirm the functionalization of PDMS surface by 1-alkenes. Though Pt-cured poly(dimethylsiloxane) elastomers are well-known in the art, it is completely unexpected and surprising that PDMS surfaces can be modified in this manner.

Accordingly, one aspect of the invention provides a surface-modified poly(dimethylsiloxane), comprising:

a Pt-cured poly(dimethylsiloxane) elastomer, having a surface; and

a plurality of —CH₂—CH₂—R groups covalently bound to the surface;

wherein R is a substituted or unsubstituted, branched or unbranched alkyl, aryl, aralkyl, alkylsilyl, silyl, alkyl ether, alkyl amine, quaternary alkyl amine, or alkylcarbonyloxy group. poly(dimethylsiloxane).

Another aspect provides a method for making the surface-modified poly(dimethylsiloxane), comprising:

contacting and hydrosilylating a surface of a Pt-cured poly(dimethylsiloxane) elastomer, the elastomer having an excess of H—Si(CH₃)(O—)₂ groups, with a plurality of —CH═CH₂—R groups;

to form a plurality of —CH₂—CH₂—R groups covalently bound to the surface;

wherein R is a substituted or unsubstituted, branched or unbranched alkyl, aryl, aralkyl, alkylsilyl, silyl, alkyl ether, alkyl amine, quaternary alkyl amine, or alkylcarbonyloxy group.

### DETAILED DESCRIPTION OF THE SEVERAL EMBODIMENTS

The R groups in the 1-alkenes are not particularly limited and may be suitably selected according to the teachings herein and the knowledge and skill of one in the art to which this application pertains. Non-limiting examples of some R groups include branched or unbranched —C₁₋₂₀ alkyl, —C₁₋₂₀ alkylamine, —C₁₋₂₀ quaternary alkylamine, —C₁₋₂₀ alkylether, or —C₁₋₂₀ alkyl halide groups.

As used herein, references to the “1-20” subscripts, and the like, specifically include a reference to any of 1, 2, 3, 4, 5, 6, 7, 8, 9, 10, 11, 12, 13, 14, 15, 16, 17, 18, 19, and 20 carbons, or any combination or subrange therein. Similarly, references to the 5-12 and 7-18 subscripts herein specifically include similar ranges, combinations or subranges.

As used herein, a halide refers to a Cl, Br or F. In some embodiments the halide is Cl or Br.

In embodiments, R is a trihydroxysilyl, trimethoxysilyl, triethoxysilyl, —C₁₋₂₀ alkyl trihydroxysilane, —C₁₋₂₀ alkyl trimethoxysilane, or —C₁₋₂₀ alkyl triethoxysilane group.

In embodiments, the —C₁₋₂₀ alkylether may be a polyethylene glycol.

In embodiments, R is a C₅₋₁₂ aryl, C₇₋₁₈ aralkyl, or C₇₋₁₈ aralkyl halide.

In embodiments, R is a C₁₋₂₀ alkylcarbonyloxy or C₁₋₂₀ haloalkylcarbonyloxy.

In embodiments, the surface-modified poly(dimethylsiloxane) of claim 1 is more hydrophilic than an unmodified Pt-cured poly(dimethylsiloxane) elastomer.

In embodiments, the surface-modified poly(dimethylsiloxane) of claim 1 is more hydrophilic than an unmodified Pt-cured poly(dimethylsiloxane) elastomer, and which does not exhibit hydrophobic recovery. hydrophobic than an unmodified Pt-cured poly(dimethylsiloxane) elastomer.

In embodiments, the —CH₂—CH₂—R groups are covalently bound to —Si(CH₃)(O—)₂ groups available at the surface or near-surface of the Pt-cured poly(dimethylsiloxane) elastomer. As an example, the —Si(CH₃)(O—)₂ groups arise from the Si—H groups (H—Si(CH₃)(O—)₂ groups) available from the excess MD^{H}DM crosslinker, shown in Scheme 1.

In embodiments, the —CH₂—CH₂—R groups are covalently bound to —Si(CH₃)(O—)₂ groups of crosslinked MD^{H}DM at the surface of the Pt-cured poly(dimethylsiloxane) elastomer. The resulting covalent attachment can be exemplified by the formula R—CH₂—CH₂—Si(CH₃)(O—)₂, wherein

The amount of excess Si—H from the resident crosslinker, MD^{H}DM, in the cured PDMS prior to hydrosilylation is not particularly limiting, so long as it is sufficient to provide available Si—H groups at the surface for hydrosilylation. Preferably, the weight ratio of base to curing agent in preparing the PDMS is about 5:1.

One or more than one type of 1-alkene may be hydrosilylated at the surface. In some embodiments, the 1-alkenes, and thus the —CH₂—CH₂—R groups covalently bound to the surface, are the same. In other embodiments, two or more different 1-alkenes (and concomitant —CH₂—CH₂—R groups covalently bound to the surface) may be used. In some embodiments, the surface-modified poly(dimethylsiloxane) includes two or more different —CH₂—CH₂—R groups covalently bound to the surface.

In some embodiments, if different 1-alkenes are desired to hydrosilylate to the surface, the PDMS can be simultaneously contacted with a mixture of the different 1-alkenes. In other embodiments, the PDMS is first contacted with a first 1-alkene, and then later contacted and reacted with a second, different 1-alkene.

It should be apparent that the surface-modified PDMS may be further reacted. That is, the R groups may be further reacted after hydrosilylation. This could be desirable in the case wherein R is a trimethoxysilyl or alkyl trimethoxysilane, which may then be further reacted with an acid such as HCl to form a trihydroxysilyl or alkyltrihydroxysilane on the surface. Similarly, R groups having alkylamines or alkyl halides may be further reacted after hydrosilylation, to produce, for example, quaternary alkylamines on the surface.

As used herein, the term, “1-alkene” is interchangeably used for convenience to refer to the CH═CH₂—R groups, although the R group may be other than alkyl.

The temperature for the hydrosilylation is not particularly limiting, and any temperature may be used to effect the reaction. Preferably, the contacting and hydrosilylating needed, however.

Similarly, the time for the hydrosilylation is not particularly limiting and may be carried out to a desired extent of surface modification. In embodiments, the contacting and hydrosilylating is carried out for a time ranging from 30 s to 2 hrs, which includes 30, 45, 60 s, 2, 3, 4, 5, 10, 20, 30, 40, 60 min, and 1.1, 1.3, 1.5, and 2 hrs. Longer or shorter times may be utilized as desired.

Upon hydrosilylation, one or more of drying, washing steps may be carried out.

### EXAMPLES

The following examples are provided for better understanding and illustration, and are not intended to be limiting.

Materials. Two platinum cured silicone elastomers, Sylgard 184 and a laboratory prepared analog were employed for demonstrating modification of surface characteristics. A Sylgard-184 kit from Dow Corning is supplied in two parts, Sylgard-184A (base) and Sylgard-184B (curing agent). According to the material safety data sheets (MSDS), Sylgard-184A is composed of dimethylvinyl-terminated dimethylsiloxane, dimethylvinylated and trimethylated silica, tetra(trimethoxysiloxy)silane (TEOS), and ethylbenzene. Sylgard-184B is composed of poly (dimethyl methylhydrogen siloxane), dimethylvinyl-terminated dimethylsiloxane, dimethylvinylated and trimethylsilylated silica, tetramethyl(tetravinyl)-cyclotetrasiloxane, and ethylbenzene. Cure into an elastomeric solid via formation of a covalently bonded network employs a platinum catalyst in Part A.

A laboratory prepared analog of Sylgard 184 was prepared from vinyl-terminated poly(dimethylsiloxane) designated M^{Vi}DM^{Vi} (MW 28 kDa) and poly(methylhydrosiloxane-co-dimethylsiloxane) that is trimethylsiloxy-terminated. The ratio of D^{H} to D is represented by the formula (MeHSiO)_{0.5-0.55}(Me₂SiO)_{0.45-0.5} with an MeHSiO range of 50-55 mol % specified by Gelest. The crosslinker is designated MD^{H}DM (MW 900-1200 Da). Cure employed a platinum-divinyltetramethyldisiloxane catalyst. All reagents were from Gelest. An inhibitor (I) 2,4,6,8-tetramethyl-2,4,6,8-tetravinylcyclotetrasiloxane, which serves to moderate the rate of cure and provides more working time before gelation, was purchased from Tokyo Chemical Industry Co, Ltd. n-Hexane (99%) was obtained from Acros Organics. n-Octane (99%), 1-octene (98%), n-dodecane and 1-dodecene were purchased from Sigma Aldrich. All chemicals were used as received. designated S-PDMS(5:1-40), where 40° C. is the cure temperature. The coatings were prepared by hand mixing the base and curing agent in a 5:1 weight ratio in a SpeedMixer container followed by high-speed mixing in a SpeedMixer-DAC 150FV (Flacktek Inc., Landrum, S.C.). High-speed (HS) mixing was employed at 3500 rpm for 60 s. This HS mixing process was repeated two times to obtain a highly viscous, bubble-free, optically transparent resin. Coverslips (Corning, 22×44×0.1 mm) were dip-coated with the freshly prepared two-component resin, immediately transferred to a vacuum oven and cured for 48 h at 40° C. (Table 1), Coated coverslips were quickly removed from the oven (N2 gas), dried and immersed in the vial containing 1-alkene.

TABLE 1
Coating compositions^{a} with 48 h cure at 40° C.

| | Divinyl PDMS | Crosslinker | Inhibitor | Pt |
|---|---|---|---|---|
| Product | (g) | (g) | (g) | catalyst |
| S-PDMS(5:1-40) | 5 (Part A) | 1 (Part B) | — | — |
| Pt-PDMS(5:1-40) | 5 | 1 (MD^{H}DM) | 0.025 | 10 μL^{d} |

^{a}S-PDMS(5:1,40) is Sylgard 184; Pt-PDMS(5:1,40) is a laboratory prepared analog of Sylgard 184.
b. Platinum catalyst is 10 wt % in hexane.

Laboratory Prepared Silicone Elastomer: To generate Pt-cured elastomers similar to Sylgard-184(40) but of known composition and without a siliceous filler, coatings were made in a manner analogous to that described by McCarthy (ACS Appl. Mater. Interfaces 2014, 6 (24), 22876-83) and Wang (ACS Appl. Mater. Interfaces 2016, 8 (22), 14252-62). In a typical preparation, 5 g M^{Vi}DM^{Vi} (Scheme 1A) resin is hand-mixed with a platinum-divinyltetramethyldisiloxane complex (10 μL, 10 wt % in hexane) followed by mixing in a SpeedMixer at 2700 rpm for 30 s. An inhibitor, 0.025 g of 2,4,6,8-tetramethyl-2,4,6,8-tetravinylcyclotetrasiloxane was added to retard gelation followed by hand-mixing and mixing in a speed mixer at 2700 rpm for 30 s (Table 1, Pt-PDMS(5:1-40). In the last step, 1 g MD^{H}DM crosslinker (Scheme 1B) was added and subjected to HS mixing under the same conditions described above. An optically transparent, viscous intermediate polymer is obtained. Dip-coated coverslips were cured as described above for S-PDMS. These coatings are designated Pt-PDMS(5:1-40) with inhibitor (Table 1).

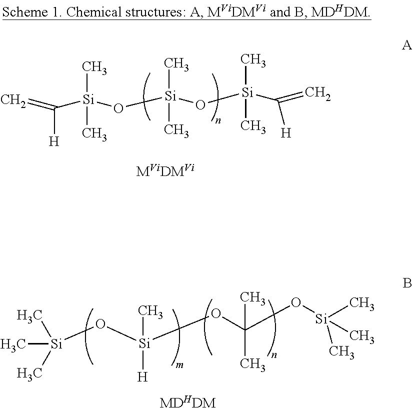

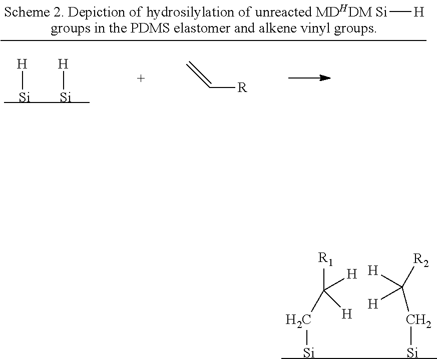

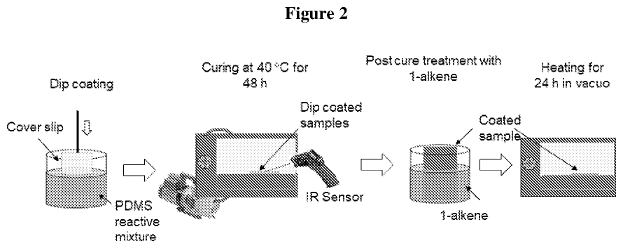

Pt-PDMS(5:1-40) coatings were cured in a vacuum oven preheated to 40° C. for 48 h. Subsequently, the coated coverslips were quickly removed from the oven, immersed in a vial containing 1-alkene. Hydrosilylation of unreacted (excess) MD^{H}DM Si—H groups in the PDMS elastomer is illustrated in FIG. 2.

Characterization

Attenuated Total Reflectance Infrared (ATR-IR) Spectroscopy: A Thermo Scientific Nicolet iS5 spectrometer equipped with a Smart iTR attachment and a germanium crystal was used for ATR-IR spectra. The Smart-iTR attachment employs a pressure of ˜40 psi that is achieved by placing the coating on the germanium crystal and turning a knurled knob until a click is obtained. Spectra were analyzed with Omnic software. The presence or absence of Si—H in the wavelength range 2100-2200 cm⁻¹ was investigated. At 2150 cm⁻¹, the wavelength for Si—H absorption, the depth of penetration of the evanescent wave is ˜200 nm using a Ge crystal.

Dynamic Contact Angles: Dynamic contact angles (DCA) were obtained by the Wilhelmy plate method on coated coverslips using a First Ten Angstroms DCA-100 contact angle tensiometer. Glass containers used for DCA analysis were cleaned by rinsing with Nanopure water and treatment with a gas/oxygen flame. Water surface tension (72.6±0.4 dyn·cm⁻¹) was checked before each experiment with a flamed glass coverslip. Contact angles Water was tested for purity after each DCA analysis to examine whether water contamination had occurred due to leached species.

Static Contact Angles: Advancing/receding static contact angles were obtained using a Rame-Hart goniometer equipped with a liquid crystal display (LCD) camera. The probe liquid was deionized water (˜18.2 Me). A water drop (20 μL) was placed on the coated surface, the image was captured immediately and analyzed for water contact angles (WCAs) by use of Dropview image software version 1.4.11. Average values were calculated from three measurements.

Water Drop Sliding Angles. The minimal tilt angle that resulted in drop-sliding was obtained with a Rame-Hart contact angle goniometer. The base was rotated from 0-90° and the angle at which a water drop started sliding was determined from visually observing the onset of water drop motion. A drop volume of 30 μL was used for these measurements.

X-ray Photoelectron Spectroscopy (XPS). Data were obtained with a Thermo Fisher ESCA lab 250 imaging X-ray photoelectron spectrometer (Al Kα (1486.68 eV)), 500 μm spot size, 50 eV pass energy, 0.1 eV step size). Samples were placed on top of conducting tape on a 5 cm×2 cm sample holder. The take-off angle was 30 or 70°. Spectra were calibrated by taking the C1s peak as 284.6 eV. Deconvolution of the N1s peak area used Avantage software (v 4.8) and a Gaussian-Lorentzian (70:30) function after smart background subtraction. To evaluate if the film was damaged by the X-ray beam, a number of scans were acquired at separate locations without noticeable changes in peak location or size.

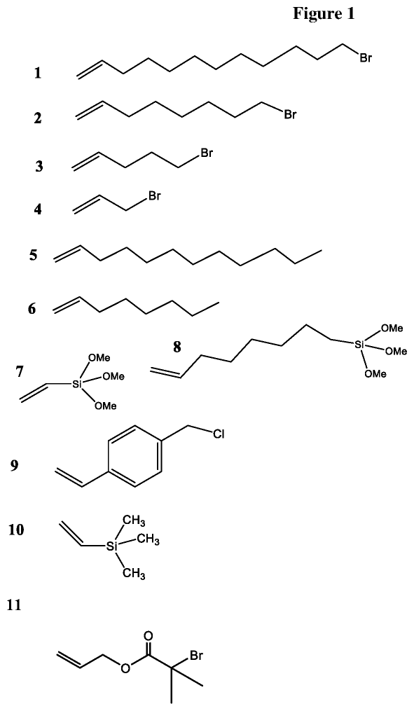

Example 1. Treatment of PDMS with 12-bromo-1-dodecene, FIG. 1-1. For this example, the initial ratio of vinyl to Si—H in Pt-PDMS coatings was ˜1:5. Therefore, the PDMS elastomer contained excess Si—H. One key to novel surface modification is the presence of excess MD^{H}DM Si—H for functionalization by using alkenes. The alkenes are not particularly limited. Non-limiting examples of suitable alkenes are shown in FIG. 1. 1-Alkenes having various functional groups designated R (Scheme 2), for example, may be used, but others are possible. The examples provided herein describe the use of one alkene but as illustrated in Scheme 2 two or more different alkenes may be employed for PDMS modification.

After drying in a nitrogen flow, S-PDMS(5:1-40) or Pt-PDMS(5:1-40) coatings were immersed in neat 12-bromo-1-dodecene for 5 min followed by rinsing with DI water for 1 min and drying in a vacuum oven at 25° C. for 6 h. One example of the steps involving the preparation of coatings and post-cure modification is illustrated in FIG. 2. described for 12-bromo-1-dodecene was carried in order to broaden the scope of alkene modification and finding quantitative evidence for surface modification from XPS.

For all modified platinum cured PDMS coatings, the absence of residual alkene was confirmed by no change in dynamic water contact angles for repeated DCA cycles.

### Results

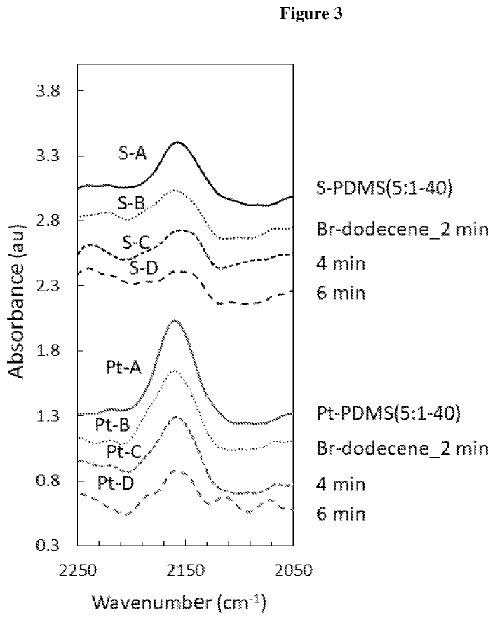

Infrared spectroscopy. FIG. 3 shows the Si—H absorption (˜2150 cm⁻¹) as a function of time for treatment with neat 12-bromo-1-dodecene (FIG. 1-1). The attenuation of the Si—H peak over just a few minutes supports rapid hydrosilylation via the reaction of excess Si—H from the MD^{H}DM crosslinker (Scheme 1B) and vinyl terminated 1-alkene. In this case the rapid reaction indicated by the attenuation of the Si—H peak occurs without added Pt catalyst.

The spectra in FIG. 3 show that the intensity of the Si—H absorption for S-PDMS(5:1-40) (FIG. 3, S-A) is about half compared to Pt-PDMS(5:1-40) (FIG. 3, Pt-A). Thus, the concentration of Si—H in commercial Sylgard 184 is about half that for the laboratory prepared coating. The attenuation of Si—H intensity is similar for S-PDMS(5:1-40) (FIG. 3, S-A [symbol] S-D) compared to Pt-PDMS(5:1-40) (FIG. 3, Pt-A [symbol] Pt-D). These results show that control of Si—H crosslinker concentration can be used to influence the degree of Pt-cured elastomer modification. In addition, the time of exposure to alkene can be used to control the extent of reaction and modification.

X-ray Photoelectron Spectroscopy (XPS). Reactions with 12-bromo-1-dodecene and 8-bromo-1-octene were aimed at finding quantitative evidence for surface modification from XPS and broadening the scope of alkene modification. Both silicone coatings, namely Pt-PDMS(5:1-40) and S-PDMS(5:1-40) (thickness 50 μm), were cured in vacuum at 40° C. for 48 h. A five-minute dip of the coatings into neat bromo-alkenes was employed followed by vacuum drying for 6 h.

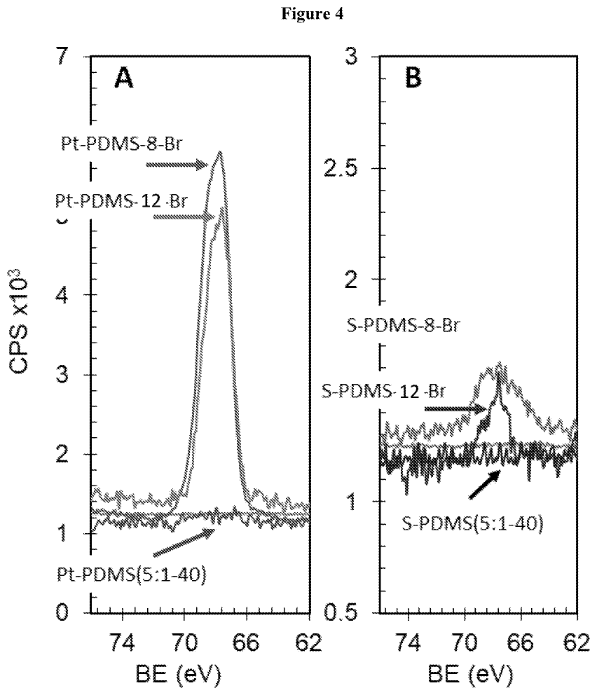

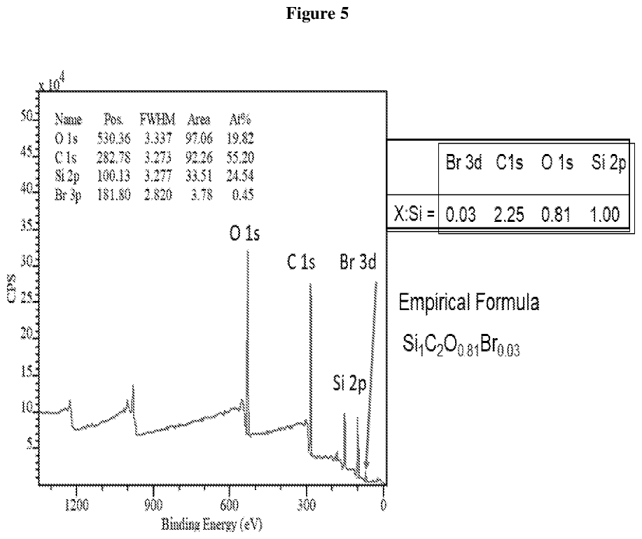

FIG. 4A shows XPS spectra for Pt-PDMS-12-Br, Pt-PDMS-8-Br where the numerical designation is for 12-bromo-1-dodecene and 8-bromo-1-octene modification, respectively. The spectrum for Pt-PDMS(5:1-40) is also shown. FIG. 3B shows spectra for Sylgard 184 (S-PDMS(5:1-40)) analogs in the binding energy region for bromine.

There is no detectable signal for Pt-PDMS-(5:1-40) but after immersion in 12-bromo-1-dodecene a peak is seen at 68 eV (FIG. 4A), which is a typical binding energy for The XPS result after simply dipping Pt-PDMS-(5:1-40) into 12-bromo-1-dodecene provides strong support for hydrosilylation of near surface Si—H. This finding flows from the hydrosilylation of temperature indicates a highly reactive in-situ catalyst and excess Si—H from the MD^{H}DM crosslinker.

As noted above, treatment with neat 8-bromo-1-octene (FIG. 1-2) was carried out using the same conditions as that described for 12-bromo-1-dodecene. The XPS spectrum for Pt-PDMS-8-Br is similar to that for the 12-carbon analog, Pt-PDMS-12-Br.

Of note are the lower Br XPS peak intensities for S-PDMS analogs (FIG. 4B). This lower intensity agrees with results from ATR-IR spectroscopy shown in FIG. 5. While the composition of Sylgard 184 is unknown, it is clear from ATR-IR and XPS spectra that there is a lower residual Si—H concentration from the crosslinker in Sylgard 184.

To gain quantitative information for composition of matter, FIG. 5 shows a survey spectrum for Pt-PDMS-Br-8. XPS spectra reflect chemical analysis for the outermost ˜5 nm, the ratio of bromine to silicon of 0.03 reflects a relatively small concentration. However, even at a concentration of ˜0.5 atom percent (FIG. 4) the presence of surface moieties can strongly influence wetting behavior, can moderate the interaction of the surface with living systems in biomedical applications, and can provide initiator sites for polymerization and further modification.

Chemical modification with 1-dodecene. As above, a Pt-PDMS(5:1-40) coating was dipped into 1-dodecene (FIG. 1-3) for ˜3 min. This trial with a model alkene parallels 1-octene (and other olefins) used by Kuhn in a study of the mechanism of hydrosilylation in solution (ACS Catalysis 2016, 6 (2), 1274-1284). However, 1-octene swells Pt-PDMS whereas swelling is negligible during immersion in 1-dodecene.

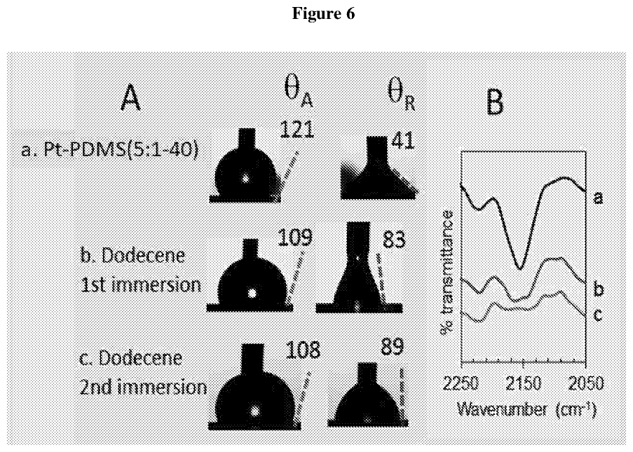

FIG. 6 shows contact angle measurements by drop addition/removal for the Pt-PDMS(5:1-40) coating. The initial receding contact angle was in the range for “low temperature cure”, viz., 41° (FIG. 6A-a) (ACS Appl. Mater. Interfaces 2016, 8 (22), 14252-62). After the first immersion in 1-dodecene, θ_{R} increased to 83°. A second 2 min immersion increased θ_{R} to 89° (FIG. 6A-b). There was no further increase after a third immersion. Immersion in dodecane had no effect on contact angles (not shown).

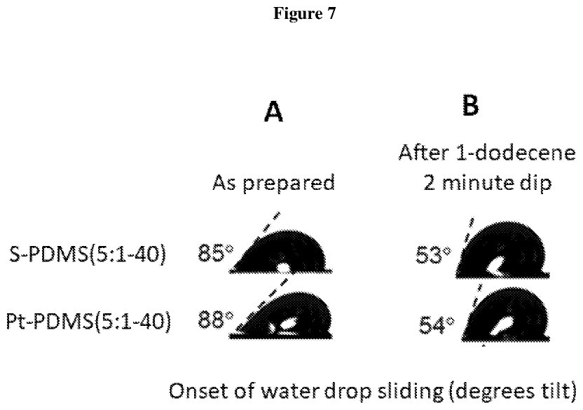

Sliding Water Drop Contact Angles. The contact angle at which a water drop on the coating surface slips off was determined using a Rame-Hart goniometer with a tilting base (from 0 to 90°). FIG. 7 shows representative images of a water drop at the onset of slipping. The water slides at lower tilting angles for the 1-dodecene treated coatings than untreated as-prepared coatings. receding contact angle from 41 to ˜90°. The rapid rate of reaction is noteworthy. Along with results for treatment of Pt-PDMS(5:1-40) with bromo-alkenes, this finding validated the presence of reactive near surface Si—H. These results raise prospects for a “green method” that avoids high temperature cure for maximizing hydrophobicity. Decreased wetting characterized by high θ_{R} is desired for applications such as icephobic coatings where the force to remove ice is proportional to the work of adhesion (wₐ), which is proportional to (1+cos θ_{R}).

Amplifying hydrophilicity. As noted above, plasma treatment is often used to confer hydrophilicity on polydimethylsiloxane elastomers. A plasma treatment of 30 seconds was found to decrease θ_{A} to 10° and θ_{R} to 5°. After plasma treatment, Sylgard 184 coatings exhibit well-known “hydrophobic recovery”, that is, θ_{A} and θ_{R} increase over a few hours or days, indicating an undesirable change of the surface from hydrophilic back to hydrophobic. Accordingly, the present method does not rely on plasma treatment, and is a surprising improvement over plasma treatment. Deposition of polydopamine and grafting PEG-containing polymers are among chemical methods to increase PDMS hydrophilicity. Decreasing protein adsorption and adhesion of printed inks for “soft electronics” are among the many applications for hydrophilic PDMS elastomers.

To confer hydrophilicity, the inventors have now developed a method following modification of Pt-PDMS with dodecene and 12-bromo-1-dodecene described above. Pt-PDMS cured at 40° C., Pt-PDMS(5:1-40), was immersed in vinyl alkyl trimethoxysilane (FIG. 1-8). Contact angles by drop addition/withdrawal for as-prepared Pt-PDMS(5:1-40) were typical for “low temperature cure”, θ_{A} 117°, θ_{R} 44° (FIG. 5 A1). The vinyl alkyl trimethoxysilane 8 was spread on the Pt-PDMS(5:1-40) coating for ˜10 min followed by a brief wash with ethanol and water, and then a dip in dilute HCl to hydrolyze Si—OCH₃ to Si—OH.

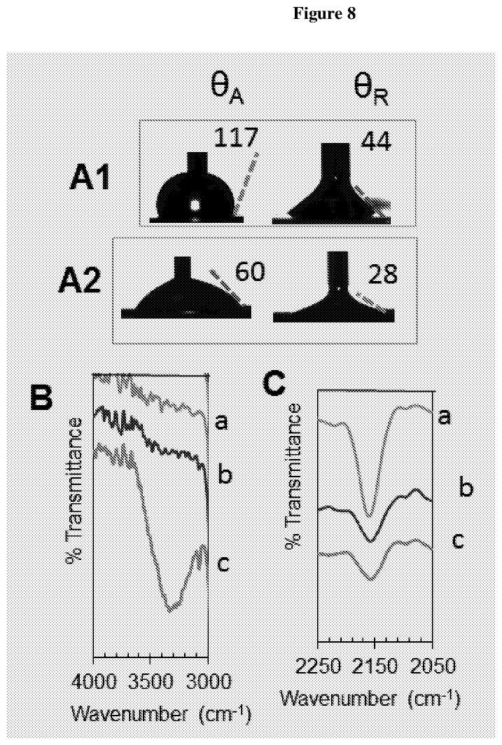

FIG. 7C shows the marked decrease in intensity of the Si—H absorption from that for Pt-PDMS(5:1-40), FIG. 8C-a, to that for Pt-PDMS(5:1-40) after treatment with 8. This attenuation reflects rapid reaction of 8 with Pt-PDMS(5:1-40).

After treatment with dilute HCl, a striking decrease in contact angles was found to θ_{A} 60°, θ_{R} 28° (FIG. 8 A2). Paralleling this increase in hydrophilicity, a prominent peak for Si—OH appeared in the IR spectrum (FIG. 8B-c). The remarkable ˜60° decrease in θ_{A} suggests that —Si(OH)₃ functionalization is homogeneously dispersed at the nanoscale rather than micro-patchy. This reasoning stems from the work of Johnson and Dettre who demonstrated that high hydrophobic surface. They reasoned that the advancing three phase contact line jumps over these patches (J. Phys. Chem. 1965, 69 (5), 1507) but that is not observed for the —Si(OH)₃-functionalized Pt-PDMS(5:1-40).

The decrease in contact angles after treatment with 8 and hydrolysis can be compared with post-plasma contact angles: θ_{A} 10° and θ_{R} 5°. However, and undesirably, after plasma treatment hydrophobic recovery is rapid. There are wide ranging reports for hydrophobic recovery depending on cure conditions, time of treatment, and coating thickness. For coatings with micron-scale thickness, contact angle values range from 60 to 90° after 3-6 h. Thus, the initial result for treatment with 8 is exceptional because hydrophobic recovery did not take place after 24 h; contact angles were the same within experimental error: θ_{A}˜60°, θ_{R}˜28°. These results were obtained using “as received” 28 kD M^{Vi}DₙM^{Vi}, MD^{H}DM (ca. 1 kDa) crosslinker and vinyl alkyl trimethoxysilane 8 from Gelest.

Reports of both advancing and receding contact angles are uncommon. The most commonly reported static contact angle is close to θ_{A} as the water drop is expanding on the substrate surface. After a PDMS plaque with a contact angle of 106° was immersed in aqueous dopamine, a contact angle of 53° has been previously reported. An overcoat of a PEG-based copolycarbonate increased the contact angle to 68-70°. By comparison, the initial 10 minute experiment with 8 that gave a decrease in contact angles to θ_{A} 60°, θ_{R} 28° as described herein is unexpected and surprising.

Surface modification with an atom-transfer radical polymerization (ATRP) initiator. A test was carried out to establish whether hydrosilylation, which occurs so readily for alkenes and 12-bromo-1-dodecene (Scheme 3), would occur for allyls. Starting with Pt-PDMS(5:1-40) conditions were found for reaction with the atom-transfer radical polymerization (ATRP) initiator allyl 2-bromo methyl propionate (FIG. 1-11) (R=haloalkylcarbonyloxy). Treatment by immersion in 9 resulted in the appearance of a strong carbonyl absorption at 1750 cm⁻¹ (in a PDMS window) and an attenuated Si—H absorption. Hydrosilylation with (FIG. 1-11) avoids plasma treatment and promises a convenient pathway for covalently bound ATRP initiation for a broad range of surface modifications.

Protein adsorption. A micro bicinchoninic acid (BCA) protein assay reagent kit is widely used to measure the amount of total protein (lysozyme) adsorbed on membranes. The amount of protein adsorbed, determined by BCA assay, determines the type of coating/membrane. expected to promote protein adsorption on the coating via hydrophobic interactions.

A Micro BCA Protein Assay Kit (#23235 from Thermo Scientific) was used to determine protein adsorption. Phosphate Buffered Saline (PBS) tablets were from Sigma Aldrich, sodium dodecyl sulphate (SDS) was obtained from Van Waters and Rogers. Lysozyme protein (egg white) was obtained from Amresco.

The kit consists of Micro BCA Reagents A, B and C (MA, MB and Mc), and bovine serum albumin (BSA) standard ampules. The test is based on bicinchoninic acid (BCA) as the detection reagent for Cu(+1), which is formed when Cu(+2) is reduced by protein in an alkaline environment. A purple reaction product is formed by the chelation of two molecules of BCA with one cuprous ion, Cu(+1). This water-soluble complex exhibits a strong absorbance at 562 nm that is linear with increasing protein concentrations.

Following the manufacturer's protocol, on day 1, a PBS solution (pH 7.2) was prepared by dissolving two PBS tablets in 400 mL Nanopure water. A solution of lysozyme protein from egg whites (0.1 mg/mL) in PBS was also prepared. PDMS coatings on 2.2×2.2 cm coverslips were placed in aluminum weighing dishes. The lysozyme solution (15 mL) was pipetted into each dish so as to immerse the coatings. These dishes were left on a rotating mixer overnight to allow adequate time for protein adsorption. On day 2, these solutions were discarded, and all coatings were rinsed with PBS to remove any unadsorbed lysozyme. The samples were then placed in Petri dishes with 3 mL of 1 wt % sodium dodecyl sulphate (SDS). A ten minute treatment in an ultrasonic was used for SDS protein desorption. The samples were flipped and treated for another 10 min for a total of 20 min.

As per the manufacturer's instructions, eight solutions of bovine serum albumin (BSA) and PBS were prepared with the following concentrations: 200, 40, 20, 10, 5, 2.5, 1, and 0.5 μg/mL. A blank solution was also prepared (0 μg/mL). The total volume of “working reagent” (WR) was calculated by

(#standards+#unknown samples)×(#replicates)×(volume of WR per sample)=(9 standards+6 unknown samples)×(2 replicates)×(150 μL)≈4.5 mL

The same procedure was used for both S-PDMS and Pt-PDMS coatings. Six coatings were comprised of two PDMS coatings immersed in 1-dodecene, two PDMS coatings immersed in dodecane, and two additional controls without exposure. As per the manufacturer, the WR was made by mixing MA, MB and Mc in the ratio 25:24:1 to give total volume of 4.5 mL. was pipetted (in duplicate) into the wells, along with 150 μL of the WR making a total of 300 μL in each well. 150 μL of each of the standards (in duplicate) was also pipetted along with 150 μL of the WR into wells separately. The plate was then incubated at 37° C. for 2 h. Under alkaline conditions (provided by MA), Cu(2+) ions of copper (II) sulphate (Mc) are reduced to Cu⁺ by the lyzosyme protein, which in turn reacts with bicinchoninic acid (BCA)(MB) to form a purplish-blue complex. After 2 h, the absorbance of was then read at 562 nm using a Biotek® Synergy H1 hybrid microplate reader. A standard curve was generated using the average absorbances of the standards. This curve was then used to determine the average protein concentration (μg/mL) corresponding to the “unknown” PDMS samples. Finally, these values were converted to μg/cm² using the surface area of coverslips, 9.76 cm².

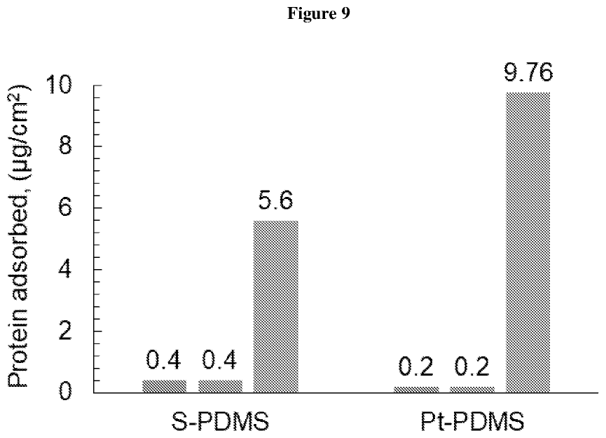

FIG. 9 shows protein adsorbed per unit area of the sample coated coverslips. The increased adsorption of protein on the 1-dodecene treated coatings was caused by the strong hydrophobic interaction between the large hydrocarbon chains and protein molecules.

The contents of the references cited herein are hereby incorporated by reference.

What is claimed is:

1. A surface-modified poly(dimethylsiloxane), comprising:
a Pt-cured poly(dimethylsiloxane) elastomer, having a surface; and
a plurality of —CH₂—CH₂—R groups covalently bound to the surface;
wherein R is a substituted or unsubstituted, branched or unbranched alkyl, aryl, aralkyl, alkylsilyl, silyl, alkyl ether, alkyl amine, quaternary alkyl amine, or alkylcarbonyloxy group.

2. The surface-modified poly(dimethylsiloxane) of claim 1, wherein R is a branched or unbranched —C₁₋₂₀ alkyl, —C₁₋₂₀ alkylamine, —C₁₋₂₀ quaternary alkylamine, —C₁₋₂₀ alkylether, or —C₁₋₂₀ alkyl halide.

3. The surface-modified poly(dimethylsiloxane) of claim 1, wherein R is a trihydroxysilyl, trimethoxysilyl, triethoxysilyl, —C₁₋₂₀ alkyl trihydroxysilane, —C₁₋₂₀ alkyl trimethoxysilane, or —C₁₋₂₀ alkyl triethoxysilane.

4. The surface-modified poly(dimethylsiloxane) of claim 1, wherein R is a C₅₋₁₂ aryl, C₇₋₁₈ aralkyl, or C₇₋₁₈ aralkyl halide.

5. The surface-modified poly(dimethylsiloxane) of claim 1, wherein R is a C₁₋₂₀ alkylcarbonyloxy or C₁₋₂₀ haloalkylcarbonyloxy.

6. The surface-modified poly(dimethylsiloxane) of claim 1, which is more hydrophilic than an unmodified Pt-cured poly(dimethylsiloxane) elastomer.

7. The surface-modified poly(dimethylsiloxane) of claim 1, which is more hydrophilic than an unmodified Pt-cured poly(dimethylsiloxane) elastomer, and which does not exhibit hydrophobic recovery.

8. The surface-modified poly(dimethylsiloxane) of claim 1, which is more hydrophobic than an unmodified Pt-cured poly(dimethylsiloxane) elastomer. CH₂—R groups are covalently bound to —Si(CH₃)(O—)₂ groups at the surface of the Pt-cured poly(dimethylsiloxane) elastomer.

10. The surface-modified poly(dimethylsiloxane) of claim 1, wherein the —CH₂—CH₂—R groups are covalently bound to —Si(CH₃)(O—)₂ groups of crosslinked MD^{H}DM at the surface of the Pt-cured poly(dimethylsiloxane) elastomer.

11. The surface-modified poly(dimethylsiloxane) of claim 1, further comprising two or more different —CH₂—CH₂—R groups covalently bound to the surface.

12. An article, comprising the surface-modified poly(dimethylsiloxane) of claim 1.

13. A method for making the surface-modified poly(dimethylsiloxane) of claim 1, comprising:
contacting and hydrosilylating a surface of a Pt-cured poly(dimethylsiloxane) elastomer, the elastomer having an excess of H—Si(CH₃)(O—)₂ groups, with a plurality of —CH═CH₂—R groups;
to form a plurality of —CH₂—CH₂—R groups covalently bound to the surface;
wherein R is a substituted or unsubstituted, branched or unbranched alkyl, aryl, aralkyl, alkylsilyl, silyl, alkyl ether, alkyl amine, quaternary alkyl amine, or alkylcarbonyloxy group.

14. The method of claim 13, wherein the contacting and hydrosilylating is carried out at ambient temperature.

15. The method of claim 13, wherein the contacting and hydrosilylating is carried out for a time ranging from 30 s to 2 hrs.

16. The method of claim 13, further comprising drying the surface-modified poly(dimethylsiloxane).
